(19) United States
(12) Patent Application Publication
(10) Pub. No.: US 2012/0022706 A1
(43) Pub. Date: Jan. 26, 2012

(54) SYSTEM AND METHOD FOR CONTROLLING A REFRIGERATION SYSTEM

(75) Inventors: Junqiang Fan, Glastonbury, CT (US); Stevo Mijanovic, South Windsor, CT (US); Yinshan Feng, South Windsor, CT (US); Degang Fu, Shanghai (CN); Runfu Shi, Shanghai (CN); Zheng O'Neill, Vernon, CT (US)

(73) Assignee: CARRIER CORPORATION, Farmington, CT (US)

(21) Appl. No.: 13/258,267

(22) PCT Filed: Feb. 23, 2010
(86) PCT No.: PCT/US2010/025029

§ 371 Date: Sep. 21, 2011

Related U.S. Application Data
(60) Provisional application No. 61/163,904, filed on Mar. 27, 2009.

(51) Int. Cl. F15D 1/00; G05D 16/20; G05D 7/06

(52) U.S. Cl. 700/282; 137/1

(57) ABSTRACT

A method and system for operating a CO2 refrigeration system is provided. Two pressures are controlled by two controllers through two valves in this system. A first valve is actuated by a first controller using a first transfer function in response to the first measured pressure. A second valve is actuated by a second controller using a second transfer function in response to the second measured pressure. When it is determining the second valve failed to operate correctly, the first valve is actuated by a third controller using a third transfer function.

### BACKGROUND OF THE INVENTION

The subject matter disclosed herein relates to a system for controlling a refrigeration system, and in particular to a system allows for operation of the Carbon Dioxide (CO₂) refrigeration system in the event a valve fails to operate.

Refrigeration systems use a thermodynamic cycle to transfer thermal energy from one location to another using a working fluid. Generally, the working fluid (such as CO₂) is compressed to form a high pressure, high temperature gas. The working fluid is then passed through a condenser or gas cooler that removes heat, causing the working fluid to condense into a high-pressure liquid. The high-pressure liquid is then transferred to a heat exchanger, commonly referred to as an evaporator. An expansion valve at the upstream of the evaporator causes a pressure drop, which throttles the working fluid into a two-phase state. The phase change from liquid to gas within the evaporator further results in absorption of thermal energy from the space being cooled. The gaseous working fluid at the exit of evaporator is then transferred back to the compressor where the cycle begins again.

In large refrigeration systems, including those used in commercial establishments such as grocery supermarket stores for example, governmental regulations have established maximum working pressures for the working fluid in areas where individuals are in close contact with the refrigeration system. Commonly, regulations only allow a maximum working fluid pressure of 40 bars (4,000 kilopascals). Unfortunately, for a refrigeration system with CO₂ as the working fluid, the operating pressure can reach up to 45˜120 bars (4,500˜12,000 kilopascals).

To achieve the desired goals of achieving high efficiency while complying with government regulations, two-stage CO₂ refrigeration systems have been proposed. In these systems, a portion of the refrigeration loop, generally outside the facility or in a machine room for example, is maintained at the high pressure levels needed for efficiency. The second portion of the loop, generally inside the facility, is operated at a lower pressure for compliance with governmental regulations. A valve is placed intermediate to the two portions of the loop to step-down or lower the pressure. Unfortunately, if the step-down valve fails to operate correctly, the entire refrigeration system needs to be disabled since it is generally not permissible to have pressurized gas over the regulated limit inside the facility. This often results in the costly dispatching of repair personnel on an exigent basis to correct the issue with the step-down valve to avoid spoilage of products being cooled by the refrigeration system.

Accordingly, while the present refrigeration systems are suitable for their intended purpose, there remains a need for improvements in the operation of the refrigeration system in the event that a valve fails to operate correctly.

### BRIEF DESCRIPTION OF THE INVENTION

According to one aspect of the invention, a method of operating a refrigeration system is provided. The method includes measuring a first pressure and a second pressure. A first valve is actuated through a first transfer function in response to the first measured pressure. A second valve is actuated through a second transfer function in response to the second measured pressure. The second valve is determined to fail to operate correctly. The first valve is actuated through a third transfer function in response to the determination of the second valve failing to operate correctly.

According to another aspect of the invention, a refrigeration system is provided having a first conduit fluidly coupled to a first valve. A second valve is fluidly coupled to the first valve. A second conduit is fluidly coupled to the second valve opposite the first valve. A first controller is electrically coupled to the first valve, the first controller being responsive to executable computer instructions for actuating the first valve to control a first pressure in the first conduit. A second controller is electrically coupled to the second valve, the first controller being responsive to executable computer instructions for actuating the second valve to control a second pressure in the second conduit. A third controller is electrically coupled to the first valve and the second valve, the third controller being responsive to executable computer instructions for actuating the first valve in response to a signal indicating the second valve failed to operate, wherein the third processor actuates the first valve to control a third pressure in the second conduit.

According to yet another aspect of the invention, a computer readable medium storing a program of instructions executable by a computer to perform a method for operating a refrigeration system is provided. The method for operating includes measuring a first pressure and a second pressure. A first valve is actuated through a first transfer function in response to the first pressure. A second valve is actuated through a second transfer function in response to the second pressure. The second valve is determined to have failed to operate correctly. The first valve is actuated through a third transfer function in response to the determination of the second valve failing to operate correctly.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustration of a prior art CO₂ refrigeration system;

FIG. 2 is a control block diagram illustration of a prior art control system for valves in the CO₂ refrigeration system of FIG. 1;

FIG. 3 is a control block diagram illustration of a control system for the refrigeration system of FIG. 1 in accordance with an embodiment of the invention; and,

FIG. 4 is a control block diagram illustration of a control system for the refrigeration system of FIG. 1 in accordance with another embodiment of the invention.

The detailed description explains embodiments of the invention, together with advantages and features, by way of example with reference to the drawings.

### DETAILED DESCRIPTION OF THE INVENTION

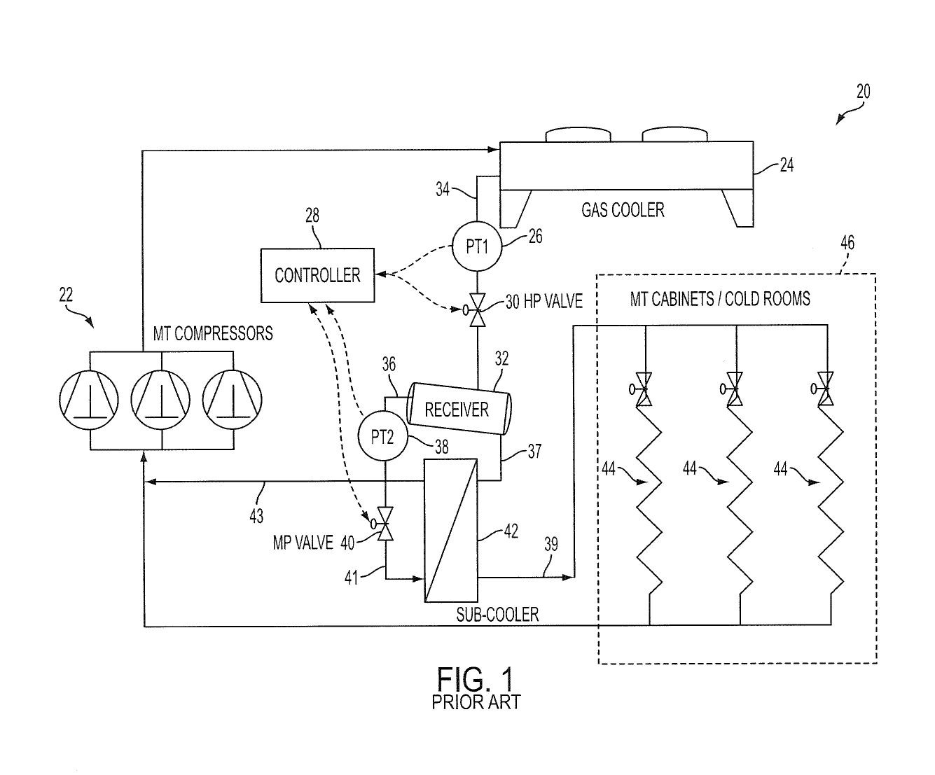

A typical prior art CO2 refrigeration system 20 is illustrated in FIG. 1. The refrigeration system 20 is a two-stage system that provides both high efficiency operation and compliance with governmental pressure regulations. The working fluid is compressed by one or more compressors 22 to a high-pressure gas, typically in 45˜420 bars (4,500˜42,000 kilopascals). The working fluid is then transferred to a cooler or condenser 24 where heat is removed and the working fluid is condensed into a high-pressure liquid. A first pressure sensor 26 coupled to a conduit 34 measures the pressure of the working fluid leaving the condenser 24. The sensor 26 outputs a signal to a controller 28, which uses the signal as a feedback for the actuation of a first (high pressure) valve 30. The high-pressure valve (HPV) 30 is modulated to maintain the desired working fluid pressure level.

The working fluid then passes into a buffer or receiver 32. The receiver 32 compensates for changes in demand in the refrigeration system 20 and separates the working fluid into a gas part and a liquid part. The gas part exits receiver 32 into a conduit 36 and passes a second (medium) pressure sensor 38. The sensor 38 transmits a signal to the controller 28 indicating the pressure in conduit 36. The controller 28 uses the signal from sensor 38 to determine the desired actuation of a medium pressure valve (MPV) 40. The actuation of valve 40 modulates the valve opening to control the working fluid pressure to be the desired pressure level for use in the facility. The liquid part of the working fluid passes a conduit 37 through a second heat exchanger or sub-cooler 42 and a conduit 39 before being transferred into the evaporators 44 in the facility 46 while the gas part passes a conduit 41 through the sub-cooler 42 and a conduit 43 before being transferred back to the compressors 22. It should be appreciated that the evaporators 44 may be used in a variety of applications such as a refrigeration cabinet or a cold room for example.

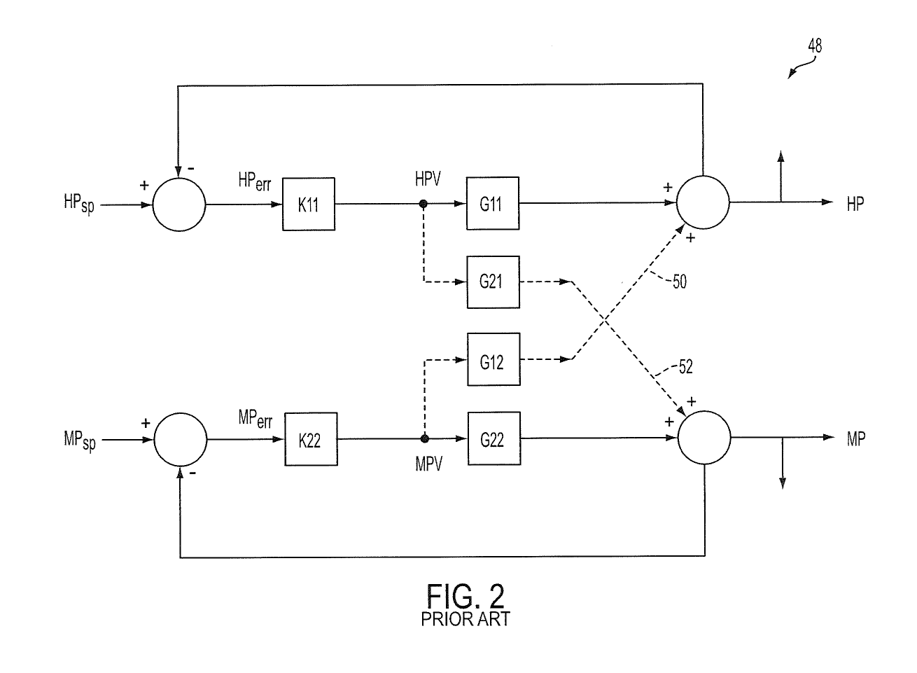

It should be appreciated that the valves 30, 40 are not independent in that the operation of one valve 30, 40 affects the output of the other. The process models from control valves to pressure can be described as the following equation:

$$[ \begin{matrix}HP \\ MP\end{matrix} ] = [ \begin{matrix}{G}_{11} ( s ) & {G}_{12} ( s ) \\ {G}_{21} ( s ) & {G}_{22} ( s )\end{matrix} ] [ \begin{matrix}HPV \\ MPV\end{matrix} ] \qquad [ Equation 1 ]$$

Where G₁₁(s) and G₂₁(s) represent the transfer function models from high pressure valve 30 to high pressure (HP) and high pressure valve 30 to medium-pressure (MP) respectively. The terms G₁₂ (s) and G₂₂ (s) represent the transfer function models from medium pressure valve 40 to HP and second valve 40 to MP respectively. A prior art control system 48, such as that illustrated in FIG. 2, used a decentralized control strategy such that the first valve 30 is to control HP through a controller K₁₁ based on the diagonal model G₁₁(s) and the second valve 40 is to control MP through another controller K₂₂ based on the diagonal model G₂₂ (s) shown in Equation 1. The off-diagonal models in Equation 1 are ignored in the prior art control strategy. The off-diagonal parts, indicated by the dashed lines 50, 52, are considered as disturbance for the control loops. As illustrated in FIG. 2, HPₛₚ and MPₛₚ signals are denoted as the setpoints of HP and MP respectively. HPₑᵣᵣ and MPₑᵣᵣ signals are the errors between the setpoint and its corresponding pressure measurement. They are used as the inputs for the controllers K₁₁ and K₂₂.

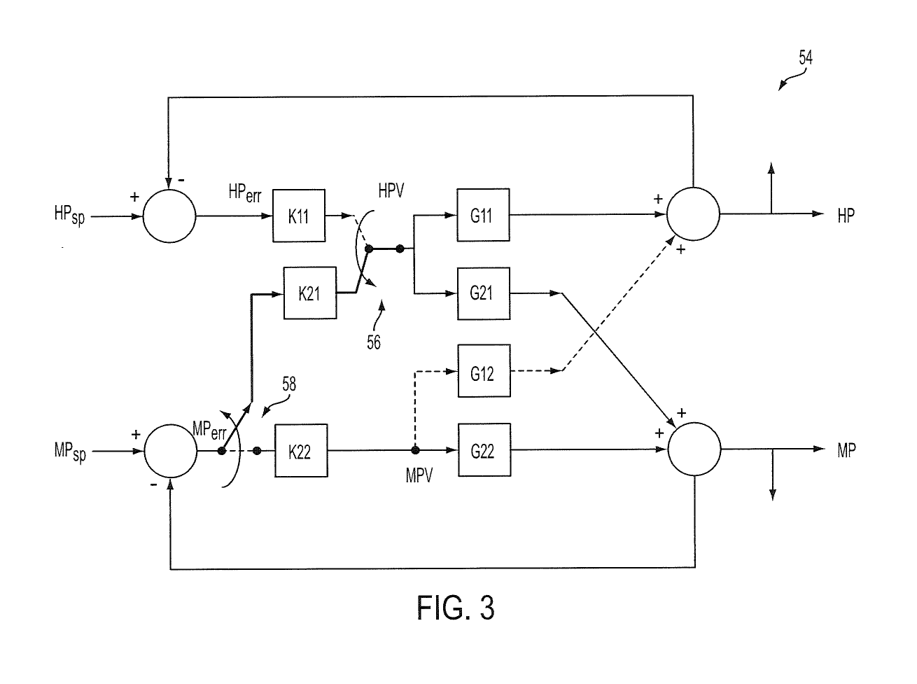

An exemplary embodiment control system block diagram 54 is illustrated in FIG. 3. This embodiment includes the controllers K₁₁, K₂₂, that provide decentralized control of the first valve 30 and the second valve 40 respectively. The controllers K₁₁, K₂₂, are arranged to receive input signals HPₑᵣᵣ and MPₑᵣᵣ, which are the errors between the setpoints (HPₛₚ and MPₛₚ) and the pressure measurements (such as from pressure sensors 26, 38 for example). The input signals HPₛₚ and MPₛₚ represent the desired working fluid pressure upstream of the first valve 30 and the second valve 40 respectively. The controllers K₁₁, K₂₂ use the input signals HPₑᵣᵣ, MPₑᵣᵣ to actuate the valves 30, 40 respectively during normal operation. It should be appreciated that actuation of the valves 30, 40 modulates the pressure of the working fluid within desired limits. As discussed above the controllers K₁₁, K₂₂ also have an impact on MP and HP through the transfer function models G₂₁ (s), G₁₂ (s) respectively.

The control system 54 further includes a third controller K₂₁ that is coupled between a first switch 56 and a second switch 58. The first switch 56 is coupled to the high-pressure input signal HPₛₚ, while the second switch 58 is coupled to the medium-pressure input signal MPₛₚ. It should be appreciated that the switches 56, 58 are arranged to either connect with the third controller K₂₁, or with the first controller K₁₁ and second controller K₂₂ respectively.

During operation, a situation may arise where the second valve 40 does not operate correctly, such as if the valve 40 becomes stuck in a particular position. In this circumstance, the valve 40 will not modulate in response to a signal from the controller K₂₂. To avoid having to disable the refrigeration system 20 due to high pressure working fluid in the facility 46 or evaporators 44, the switches 56, 58 move from their first or normal operating position, e.g. the signal HPₑᵣᵣ is used by the controller K₁₁ as an input to modulate the high-pressure valve 40, and the signal MPₑᵣᵣ is used by the controller K₂₂ as an input to modulate the second valve 40, to a second position shown in FIG. 3. When in the second position, the controller K₂₁ receives the input signal MPₑᵣᵣ. The controller K₂₁ then uses the input signal MPₑᵣᵣ with the transfer function model G₂₁(s) to modulate the first valve 30 to control the pressure of the working fluid down stream from the second valve 40. The pressure of the working fluid downstream of the second valve 40 is controlled to a desired level, such as 35 bar (3,500 kilopascals).

The control system 54 of FIG. 3 provides the advantage of being able to control the medium pressure of the working fluid entering the facility 46 and/or the evaporators 44 below desired pressure limit, such as a governmental regulated pressure limit, in the event of a failure of the second valve 40. This allows the refrigeration system 20 to continue operation and maintain the desired temperature levels in the areas being cooled. Thus, the probability of spoilage and the need for repairs on an expedited basis is avoided.

It should be appreciated that when the switches 56, 58 actuate to the second position to control the pressure level of the working fluid downstream of the second valve 40, control of the working fluid pressure upstream of the first valve 30 may be limited. In another embodiment, the switch 56 modulates between the first position, connecting with the controller K₁₁, and the second position connecting with the controller K₂₁. This embodiment provides the additional advantage of allowing for control of the pressure upstream of the first valve 30 within a desired range, such as 80˜100 bars (8,000˜10,000 kilopascals) while also controlling the pressure downstream of the second valve 40 within desired operating pressure limits, such as 32˜35 bar (3,200˜3,500 kilopascals).

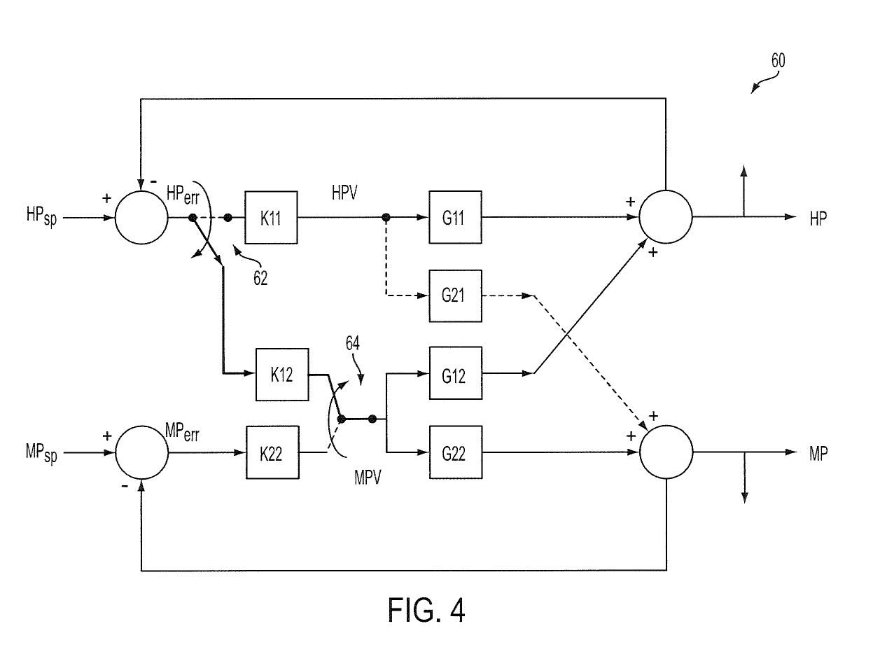

Another embodiment control system block diagram 60 is illustrated in FIG. 4. In some applications, it may also be desirable to provide control of the pressure upstream of the first valve 30 in the event the first valve 30 fails to operate correctly. The control system 60 includes controllers K₁₁ and K₂₂ to provide actuation of the valves 30, 40 during normal operation as described herein above. Control system 60 further includes a third controller K₁₂ coupled between the input signal HPₑᵣᵣ and the second valve 40 by a first switch 62 and a second switch 64. During normal operation, the first switch 62 is arranged in a first position to direct the input signal HPₑᵣᵣ to the controller K₁₁. Similarly, during normal operation, the second switch 64 is arranged to direct the output of the controller K₂₂ to the second valve 40.

In the event that an issue arises with the first valve 30, such that it does not operate correctly, the switches 62, 64 change to a second position. In the second position, the first switch 62 directs the input signal HPₑᵣᵣ to the third controller K₁₂. The second switch 64 also changes position connecting the third controller K₁₂ to the second valve 40. In this arrangement, the third controller K₁₂ adjusts the second valve 40 through the model G₁₂ (s) to control the working fluid pressure upstream of the first valve 30. This provides the advantage of allowing the refrigeration system 20 to remain in operation when the first valve 30 fails to operate correctly. Further, in another embodiment, the switch 64 is arranged to modulate between the second controller K₂₂ and the third controller K₁₂ to maintain pressure both upstream of the first valve 30 and downstream of the second valve 40 within desired ranges.

In another embodiment, the switches 56, 58 of FIG. 3 are combined with the switches 62, 64 to provide a control system that may provide for pressure control in the event that either of the valves 30, 40 fail to operate correctly.

It should be appreciated that while the embodiments herein are described with reference to discrete controllers K₁₁, K₂₂, K₁₂, K₂₁, these controllers may also be embodied in the form of a computer-implemented process or analog circuits. These controllers K₁₁, K₂₂, K₁₂, K₂₁, may also be computer-implemented processes incorporated on a single controller, such as controller 28 for example, having a processor. The methods disclosed herein may further be stored as instructions on a computer readable medium coupled to one or more processors for carrying out the instructions. The computer readable medium may be in the form of read-only memory (ROM), random-access memory (RAM) or non-volatile memory (NVM).

The controllers include operation control methods embodied in application code, such as that shown in FIG. 3 and FIG. 4. These methods are embodied in computer instructions written to be executed by a processor, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

Further, the controllers may be a suitable electronic device capable of accepting data and instructions, executing the instructions to process the data, and presenting the results. Controllers may accept instructions through user interface, or through other means such as but not limited to electronic data card, voice activation means, manually operable selection and control means, radiated wavelength and electronic or electrical transfer. Therefore, the controllers can be a microprocessor, microcomputer, a complex instruction set computer, an ASIC (application specific integrated circuit), a reduced instruction set computer, an analog computer, a digital computer, a computer network, a desktop computer, a laptop computer, or a hybrid of any of the foregoing.

It should be appreciated that while the embodiments disclosed herein describe the refrigeration system in relation to specific pressures or pressure ranges, such as 35 bar (3,500 kilopascals) and 100 bar (10,000 kilopascals) for example, this is for exemplary purposes and the claimed limitation should not be so limited.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to manage the pressure control in a refrigeration system where one or more valves have failed to operate correctly.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of operating a refrigeration system PO comprising:
measuring a first pressure;
measuring a second pressure;
actuating a first valve through a first transfer function in response to said first measured pressure;
actuating a second valve through a second transfer function in response to said second measured pressure;
determining said second valve failed to operate correctly; and,
actuating said first valve through a third transfer function in response to said determination of said second valve failing to operate correctly.

2. The method of claim 1 wherein said first valve is connected through said third transfer function to control said second pressure in a first conduit fluidly coupled to said second valve.

3. The method of claim 2 wherein said second pressure is less than 4000 kilopascals.

4. The method of claim 2 wherein said second valve is connected through said fourth transfer function to control a second pressure in a second conduit fluidly coupled to said first valve.

5. The method of claim 4 further comprising the step of switching said connection of said second valve between said second transfer function and said third transfer function to control said second pressure below 12,000 kilopascals and said first pressure below 4000 kilopascals.

6. The method of claim 2 wherein said first pressure is within less than 12,000 kilopascals.

7. The method of claim 6 wherein said first pressure is 4500 kilopascals to 12,000 kilopascals.

8. A refrigeration system comprising:
a first conduit;
a first valve fluidly coupled to said first conduit;
a second valve fluidly coupled to said first valve;
a second conduit fluidly coupled to said second valve opposite said first valve;
a first controller electrically coupled to said first valve, said first controller being responsive to executable computer instructions for actuating said first valve to control a first pressure in said first conduit;
a second controller electrically coupled to said second valve, said first controller being responsive to executable computer instructions for actuating said second valve to control a second pressure in said second conduit; and,
a third controller electrically coupled to said first valve and said second valve, said third controller being responsive to executable computer instructions for actuating said first valve in response to a signal indicating said second valve failed to operate, wherein said third processor actuates said first valve to control a third pressure in said second conduit.

9. The refrigeration system of claim 8 wherein said first controller, said second controller and said third controller use the same processor.

10. The refrigeration system of claim 9 wherein said third controller actuates said first valve to control said second pressure to be less than 4000 kilopascals.

11. The refrigeration system of claim 10 wherein said first controller actuates said first valve to control said first pressure to be within 4500 kilopascals to 12,000 kilopascals.

12. The refrigeration system of claim 11 further comprising a switch operably coupled to said first controller and said third controller, wherein said switch is responsive to executable computer instructions alternatively couple said first valve between said first controller and said third controller to control said first pressure to be within 4,500 kilopascals to 12,000 kilopascals and said second pressure to be less than 4,000 Kilopascals.

13. The refrigeration system of claim 12 wherein said switch operates on said processor.

14. A computer readable medium storing a program of instructions executable by a computer to perform a method for operating a refrigeration system, comprising:
measuring a first pressure;
actuating a first valve through a first transfer function in response to said first pressure;
measuring a second pressure;
actuating a second valve through a second transfer function in response to said second pressure;
determining said second valve failed to operate correctly; and,
actuating said first valve through a third transfer function in response to said determination of said second valve failing to operate correctly.

15. The computer readable medium of claim 14 wherein said first valve is connected through said third transfer function to control said second pressure in a first conduit fluidly coupled to said second valve.

16. The computer readable medium of claim 15 wherein said second pressure is less than 4000 kilopascals.

17. The computer readable medium of claim 15 wherein said second pressure is below 12,000 kilopascals.

18. The computer readable medium of claim 15 further comprising the step of step of switching said connection of said second valve between said second transfer function and said third transfer function to control said second pressure below 12,000 kilopascals and said first pressure below 4000 kilopascals.
